(19) United States
(12) Patent Application Publication
(10) Pub. No.: US 2018/0040164 A1
(43) Pub. Date: Feb. 8, 2018

(54) APPARATUS AND METHODS FOR SELECTIVE CODING OF IMAGES

(71) Applicant: GoPro, Inc., Carlsbad, CA (US)

(72) Inventors: David Newman, San Diego, CA (US); Adeel Abbas, Carlsbad, CA (US); Brian Schunck, San Diego, CA (US)

(21) Appl. No.: 15/230,236

(22) Filed: Aug. 5, 2016

(51) Int. Cl. G06T 19/00; G06F 3/01

(52) U.S. Cl. CPC G06T 19/006; G06F 3/013; H04N 19/63

(57) ABSTRACT

Apparatus and methods for resolution based, selective retrieval, of various portions of video content for e.g., accelerated rendering. Embodiments described herein select different portions of content to retrieve at different resolutions; content of interest can be rendered at high resolution, boundary content can be retrieved and/or rendered at low resolution. By selectively retrieving and rendering the video content, a greater portion of rendering resources can be allocated to content of interest and/or rendering resources can be reduced for boundary content. Rendering resources may include (but are not limited to) processing power, device battery life, network bandwidth, device storage or latency of switching content of interest. In this manner, even platforms with limited rendering resources can provide an equivalent (if not better) user experience than much more capable prior art platforms.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### Field of the Disclosure

The present disclosure relates generally to storing and/or presenting of image and/or video content, and more particularly in one exemplary aspect to resolution-based, selective retrieval of various portions of video content for accelerated rendering.

### Description of Related Art

So-called “virtual reality” (VR) (and its mixed reality progeny; e.g., augmented reality, augmented virtuality, etc.) is a computer technology that seeks to create an artificial environment for user interaction. Current prototypes render video, audio, and/or tactile content through a display consistent with the user's movement. For example, when a user tilts or turns their head, the image is also tilted or turned proportionately (audio and/or tactile feedback may also be adjusted). When effectively used, VR and VR-like content can create an illusion of immersion within an artificial world. Additionally, since the viewer is not physically constrained by the human body, the VR experience can enable interactions that would otherwise be difficult, hazardous, and/or physically impossible to do. VR has a number of interesting applications, including without limitation: gaming applications, medical applications, industrial applications, space/aeronautics applications, and geophysical exploration applications.

Existing VR solutions must render the image according to the viewer's movements (which are arbitrary and not known ahead of time) with sufficient responsiveness to sustain the illusion of immersion within the artificial world. Thus, prior art VR solutions require significant processing resources and are limited to expensive hardware platforms. These requirements prohibit widespread adoption of VR and VR-like content. Accordingly, less onerous techniques are needed to enable VR and VR-like content on a wider range of devices and applications.

### SUMMARY

The present disclosure satisfies the foregoing needs by providing, inter alia, methods and apparatus for storing and/or presenting of image and/or video content and more particularly in one exemplary aspect to resolution based, selective retrieval of various portions of video content for accelerated rendering.

A method for storing various portions of video content data for selective retrieval is disclosed. In one embodiment, the method includes: receiving image content data rendered at an original resolution; subdividing the image content data into a plurality of components; indexing the plurality of components with at least a resolution and one or more location coordinates; and storing the indexed plurality of components within a data storage device.

In one variant, the subdividing the image content data into a plurality of components comprises encoding the image content data with a wavelet transform. In one exemplary variant, the wavelet transform generates a coarse component, a vertical edge component, a horizontal edge component, and a diagonal edge component; and portions of each one of the coarse component, the vertical edge component, the horizontal edge component, and the diagonal edge component can be arbitrarily addressed.

In a second variant, the subdividing further comprises subdividing at least one of the plurality of components into a plurality of regions; and each one of the plurality of regions can be decoded without reference to another region. In one such variant, the method further comprises entropy encoding each one of the plurality of regions. In one such case, the plurality of regions comprises a plurality of tiles, slices or bands.

A method for retrieving various portions of video content data for selective rendering is disclosed. In one embodiment, the method includes: identifying one or more location coordinates associated with content of interest; identifying boundary content proximate to the content of interest; retrieving one or more components of an original image associated with the content of interest and the boundary content; and rendering the content of interest from the retrieved one or more components.

In one variant, the identifying one or more location coordinates is based on receiving one or more of roll, pitch, and yaw input from one or more accelerometers of a viewing device.

In a second variant, the identifying one or more location coordinates is based on receiving eye-tracking information.

In a third variant, the method includes retrieving the one or more components comprises retrieving components associated with different resolution qualities.

In a fourth variant, the retrieving one or more components comprises retrieving first components associated with the content of interest and a first resolution. In one such case, the retrieving one or more components comprises retrieving second components associated with the boundary content and a second resolution. In one such case, the method includes rendering at least a portion of the boundary content at the second resolution. In another such case, the method includes buffering at least a portion of the boundary content at the second resolution.

An apparatus configured to selectively render a portion of an image at a selected resolution is disclosed. In one embodiment, the method includes: a data interface; a memory configured to store data relating to a plurality of components associated with an original image; a processor in data communication with the data interface; and a storage apparatus. In one exemplary embodiment, the storage apparatus includes a non-transitory computer readable medium comprising one or more instructions which are configured to, when executed by the processor, cause the apparatus to: retrieve only a subset of the data relating to the plurality of components, the subset associated with content of interest and boundary content; wherein the components associated with the content of interest have a different resolution from that of the components associated with the boundary content; and cause provision of at least the content of interest to a display device via the data interface, so as to enable rendering of a display thereof.

In one variant, the apparatus further includes: one or more accelerometers; and the content of interest is determined based on input from the one or more accelerometers.

In a second variant, the apparatus further includes: one or more eye-tracking cameras; and the content of interest is determined based on input from the one or more eye-tracking cameras.

In a third variant, the apparatus includes computerized logic configured to determine a total number of components of the subset based on a processing limitation of the processor or a memory limitation of the memory. In one variant, the enabled rendering is based on a first set of components associated with the content of interest. In another variant, the enabled rendering is also based on a second set of components associated with the boundary content.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a graphical representation of one exemplary camera system including two (2) fisheye cameras useful in conjunction with the various aspects disclosed herein.

FIG. 2 is a graphical representation of one exemplary camera system including six (6) cameras useful in conjunction with the various aspects disclosed herein.

FIG. 3 is a graphical representation of one exemplary virtual reality (VR) head set useful in conjunction with the various aspects disclosed herein.

FIG. 4 is a logical flow diagram of one generalized method for processing (e.g., storing) various portions of video content for selective retrieval, in accordance with the principles described herein.

FIG. 5 is a graphical representation of one exemplary wavelet encoding scheme.

FIG. 6 is a logical flow diagram of one generalized method for retrieving various portions of video content for selective rendering, in accordance with the principles described herein.

FIG. 7 is a graphical representation of one exemplary usage scenario, in accordance with the generalized methods described herein.

FIG. 8 is a logical block diagram of one exemplary apparatus.

All Figures disclosed herein are © Copyright 2016 GoPro Inc. All rights reserved.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to a single implementation or implementation, but other implementations are possible by way of interchange of, or combination with, some or all of the described or illustrated elements. Wherever convenient, the same reference numbers will be used throughout the drawings to refer to same or like parts.

### Overview

The present disclosure discloses apparatus and methods for resolution-based, selective retrieval, of various portions of video content for e.g., accelerated rendering. Various embodiments of the present disclosure select high resolution portions of the content to render and/or buffer that content which is of interest, and select low(er) resolution portions of the content to render and/or buffer content that is not of interest, but still may be useful (e.g., “boundary content”). By selectively retrieving and rendering the video content, a greater portion of rendering resources can be allocated to content of interest, and/or likewise reduced for boundary content. In this manner, even platforms with limited rendering resources can provide an equivalent (if not better) user experience than much more capable prior art platforms.

Various disclosed implementations leverage video content that has been compressed according to an exemplary wavelet encoded format. In one such exemplary embodiment, the wavelet encoding is indexed according to image coordinates and resolutions. Unlike existing video and image content formats that are aggregated into a single payload which must be decoded and decompressed in aggregate; the described wavelet encoding of the present disclosure has a payload which has been subdivided into low energy/frequency components, and high energy/frequency components along various dimensions. Video content of interest is retrieved and rendered at the highest available resolution from the components, whereas video content at the periphery (boundary content) is retrieved and rendered at lower resolutions from a subset of the components.

Still other applications and implementations will be made apparent to artisans of ordinary skill in the related arts, given the contents of the present disclosure.

### Existing Panoramic and Virtual Reality (VR) Content—

As a brief aside, panoramic content (e.g., content captured using 180°, 360° and/or other fields of view (FOV)) and/or virtual reality (VR) content, may be characterized by high image resolution and/or high bit rates. Various resolution formats that are commonly used include e.g., 7680×3840 (also referred to as “8K” with a 2:1 aspect ratio), 7680×4320 (8K with a 16:9 aspect ratio), 3840×1920 (also referred to as “4K” with a 2:1 aspect ratio), 3840×2160 (4K with a 16:9 aspect ratio). Existing bit rates can exceed fifty (50) megabits per second (Mbps). In some cases, panoramic content may be created by stitching together multiple images; in other cases, panoramic content may be generated according to e.g., computer modeling, etc. Similarly, VR content and VR-like content may be dynamically generated based at least in part on computer models and user viewing input (e.g., head tilt and motion parameters, such as pitch, yaw, and roll)

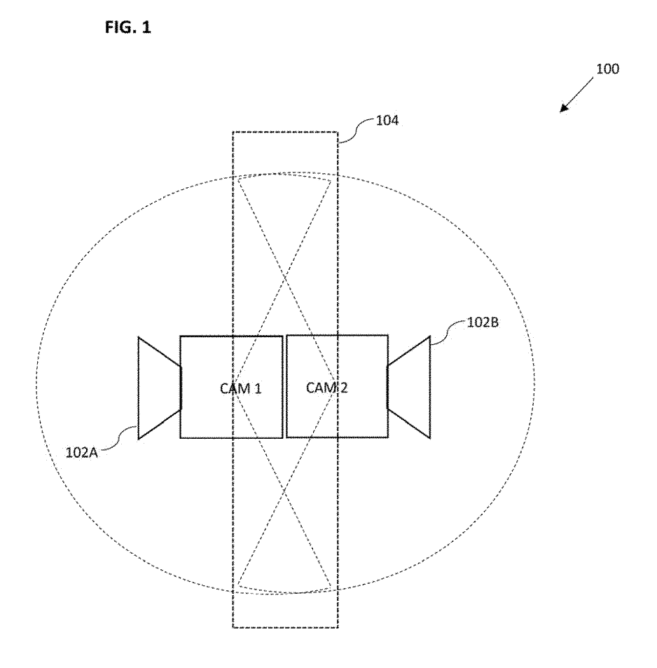

For example, FIG. 1 depicts one exemplary camera system 100 that includes two (2) spherical (or “fish eye”) cameras (102A, 102B) that are mounted in a back-to-back configuration (also commonly referred to as a “Janus” configuration). As used herein, the term “camera” includes without limitations sensors capable of receiving electromagnetic radiation, whether in the visible band or otherwise (e.g., IR, UV), and producing image or other data relating thereto. The two (2) source images in this example have a 180° or greater field of view (FOV); the resulting images may be stitched along a median 104 between the images to obtain a panoramic image with a 360° FOV. The “median” in this case refers to the overlapping image data from the two (2) cameras. Stitching is necessary to reconcile the differences introduced based on e.g., lighting, focus, positioning, lens distortions, color, etc. Stitching may stretch, shrink, replace, average, and/or reconstruct imaging data as a function of the input images. Janus camera systems are described in e.g., U.S. Design patent application Ser. No. 29/548,661, entitled “MULTI-LENS CAMERA” filed on Dec. 15, 2015, and U.S. patent application Ser. No. 15/057,896, entitled “UNIBODY DUAL-LENS MOUNT FOR A SPHERICAL CAMERA” filed on Mar. 1, 2016, which is incorporated herein by reference in its entirety.

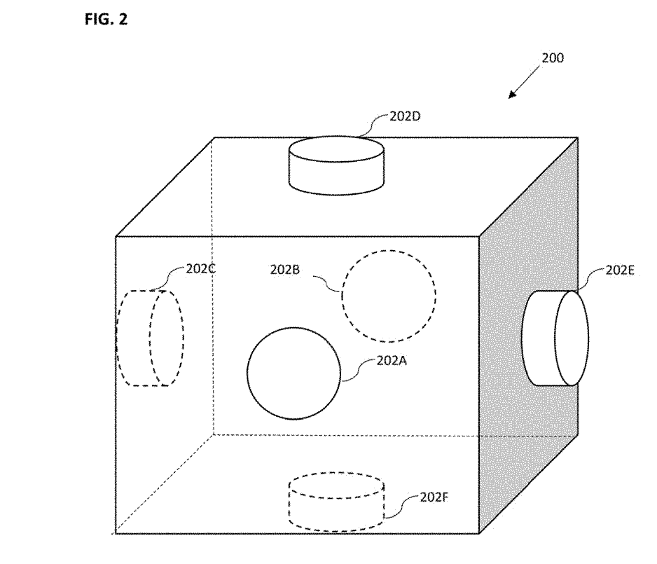

FIG. 2 illustrates another exemplary camera system 200 that includes six (6) cameras (202A, 202B, 202C, 202D, 202E, 202F) that are mounted according to a cube chassis. The greater number of cameras allows for less distortive lens effects (i.e., the source images may be anywhere from 90° to 120° FOV and rectilinear as opposed to wider spherical formats). As with FIG. 1, the six (6) source images of FIG. 2 may be stitched to obtain images with a 360° FOV. The stitched image may be rendered in an equirectangular projection (ERP), cubic projection and/or other projection. The six (6) images can be combined to provide a full 360° FOV regardless of horizontal or vertical view angle.

Other panoramic imaging formats may use a greater or fewer number of cameras along any number of viewing axis to support a variety of FOVs (e.g., 120°, 180°, 270°, 360°, etc.) For example, a four (4) camera system may provide 360° horizontal panorama with a 120° vertical range. Under certain conditions, a single camera may be used to catch multiple images at different views and times; these images can be stitched together to emulate a much wider FOV assembly. Still other camera rig configurations may use multiple cameras with varying degrees of overlapping FOV, so as to achieve other desirable effects (e.g., better reproduction quality, three dimensional (3D) stereoscopic viewing, etc.)

Panoramic content can be viewed on a normal or widescreen display; movement within the panoramic image can be simulated by “panning” through the content (horizontally, vertically, or some combination thereof), zooming into and out of the panorama, and in some cases stretching, warping, or otherwise distorting the panoramic image so as to give the illusion of a changing perspective and/or field of view. One such example of “warping” a viewing perspective is the so-called “little world” projection (which twists a rectilinear panorama into a polar coordinate system; creating a “little world”). Common applications for viewing panoramic content include without limitation: video games, geographical survey, computer aided design (CAD), and medical imaging. More recently, advances in consumer electronics devices have enabled varying degrees of hybrid realities, ranging on a continuum from complete virtual reality to e.g., augmented reality, mixed reality, mixed virtuality, etc.

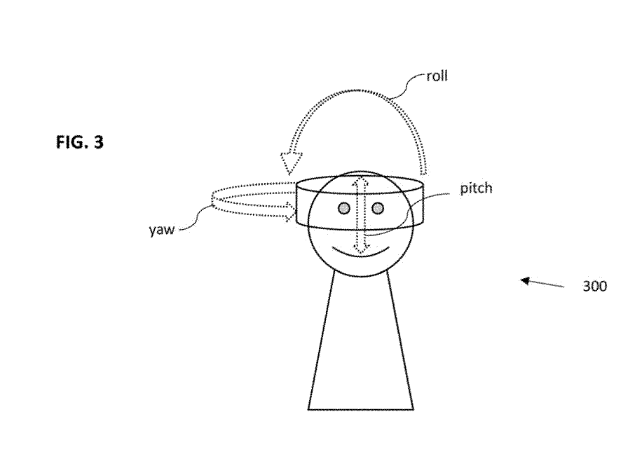

Referring now to FIG. 3, one exemplary VR head set 300 is illustrated for rendering panoramic and/or VR specific content. The VR head set monitors the head's roll, pitch, yaw, and/or other motion information to identify and display a portion of the VR-content to the user. The head tilt information in this instance is gathered based on one or more headset mounted sensors (e.g., accelerometers, positioning sensors, etc.) and/or other user inputs (e.g., joystick, mouse, keyboard, speech recognition system, etc.). The portion of the VR-content that should be displayed is identified by the headset, and is either retrieved from locally buffered VR-content on the VR head set, or requested from an external source (e.g., content servers). The portion is then displayed for the user; the refresh latency should be shorter than that which can be humanly perceived in order to maximize user experience. Other media may be similarly modified e.g., acoustic playback may amplify or attenuate the audio tracks for the left and right ear or adjust their relative phase (so as to simulate the user's ears moving relative to a fixed sound source), consistent with head tilt, and tactile and/or haptic feedback may be used to simulate a virtual object's physical qualities (e.g., force feedback, simulating “alive” matter).

Since VR head sets are expensive and can be cumbersome, consumer tastes have shifted to less immersive but more convenient VR-like environments where similar accelerometer and/or geolocation based information can be used in place of the head tilt information. For example, a smart phone can display a virtualized environment based entirely on internal computer modeling, which allows the user to freely pan and/or move consistent with the phone's sensed movement and/or the user interface (e.g., swiping, tapping, etc.). In some cases, a rudimentary VR head set may be approximated by attaching the phone to the user's face (such as is done with e.g., Google Cardboard).

Another common use scenario is based on augmenting the smart phone's camera capabilities by overlaying a virtualized object on the camera's image in a persistent manner. In some cases, the virtual object may be anchored to a particular location or marker (e.g., based on visual recognition and/or location information). For example, a smart phone may use a QR-code sticker to identify a source of augmented content (such as an URL), and also as a positional anchor within the camera image for the object overlay. Various other hybrid reality implementations will be readily appreciated by those of ordinary skill in the related arts, given the contents of the present disclosure.

Unfortunately, VR applications have a number of practical constraints that limit its widespread use on limited resource devices (such as the aforementioned smart phone). Unlike traditional video rendering, the rendering latency of the VR display in response to user movement should be imperceptible to the user (i.e., the illusion of immersion is lost or at least degraded if the user can move their head faster than the display can update). Consequently, prior art VR operation rendered most (if not all) of the VR content on the headset (or other rendering device), but only displayed a portion of it to the user. More directly, as the user moved their head, the other “hidden” portions of the VR content were “revealed” from the previously buffered content. The buffered full resolution content could be replenished without adversely affecting the user experience. However, since much of the buffered full resolution content is not used and discarded, the existing solutions are very inefficient.

Smart phones and tablets have significant performance limitations that are not present in more traditional VR head sets. For example, smart phones have a limited battery life and relatively weaker processing power as compared to a VR head set. Additionally, while a VR head set may have a dedicated high speed wired connection to the content server, smart phones may be limited to the bursty and/or slower speeds of a cellular or other wireless connection over an internet gateway, etc. The limitations of the smart phone platform create significant obstacles for prior art VR solutions; in particular, there are bandwidth limitations which can cause the flow of data to “stall out” or behave erratically while retrieving and rendering VR content that is displayed to the user.

Further exacerbating matters, image content is encoded and heavily compressed in aggregate (to maximize encoding efficiency), and must also be decoded in aggregate. Within the context of limited processing platforms (such as smart phones, etc.), the prior art conservative buffering scheme is computationally expensive and extraordinarily inefficient, as the entire environment must be rendered in full high resolution, even though only a portion of the content is displayed.

While prior art buffering solutions were suitable for expensive VR headsets, incipient research is directed to providing the VR or VR-like experience on devices that have significant resource limitations. For example, a user may wish to view VR-like content on a resource-limited device (e.g., a head mounted smart phone) and/or other devices characterized by a given amount of available energy, data transmission bandwidth, and/or computational capacity. Such resource-limited devices are generally inadequate to process full resolution and/or full frame high resolution image content in a manner that provides a satisfactory user experience.

More directly, while prior art VR solutions used a conservative buffering scheme to support the required responsiveness for immersion, such solutions required expensive platform hardware resources (e.g., processing, memory, power, etc.) To these ends, efficient schemes are needed for providing VR and/or VR-like content to rendering devices with less stringent hardware requirements. Ideally, such solutions reduce the amount of content that must be buffered, while still supporting fast rendering latencies for a truly immersive experience.

### Methods—

While the following discussions are presented primarily within the context of panoramic and VR content, artisans of ordinary skill in the related arts, given the contents of the present disclosure, will readily appreciate that the various aspects described herein may be utilized in any application that would benefit from selective viewing of portions of an image or other sensor data, and/or selective access to various resolutions or “qualities” of the image or data. For example, many extant imaging processing algorithms (such as photo editing software) render an image and then down sample the rendered image prior to processing; thus, selective access to a down sampled version of an image may reduce the initial processing load.

In one aspect, the following methods describe storing and retrieving portions of image data according to location coordinates and resolution information. As previously noted, such applications may include, but are not limited to, e.g., gaming, medical, industrial, space/aeronautical, and geophysical exploration applications. As but one particular example, magnetic resonance imaging (MRI) data can provide a 3D model of a human body, of which 2D slices or 3D representations may be selectively rendered at any number of resolutions. Similar applications may be used with computer aided design (CAD) and geophysical mappings to e.g., zoom-in/out of an image, produce wireframe models, vary translucency in visualizations, and/or dynamically cut-away layers of visualizations, etc. Likewise, multi-sensor “fused” data systems (such as the Rockwell Collins F-35 JSF Helmet Mounted Display, which permits the pilot to “look” through the airframe of the aircraft) can benefit from the various features disclosed herein (e.g., to enable more rapid processing and update based on rendering areas where a pilot is currently looking differentially from those where he or she is not).

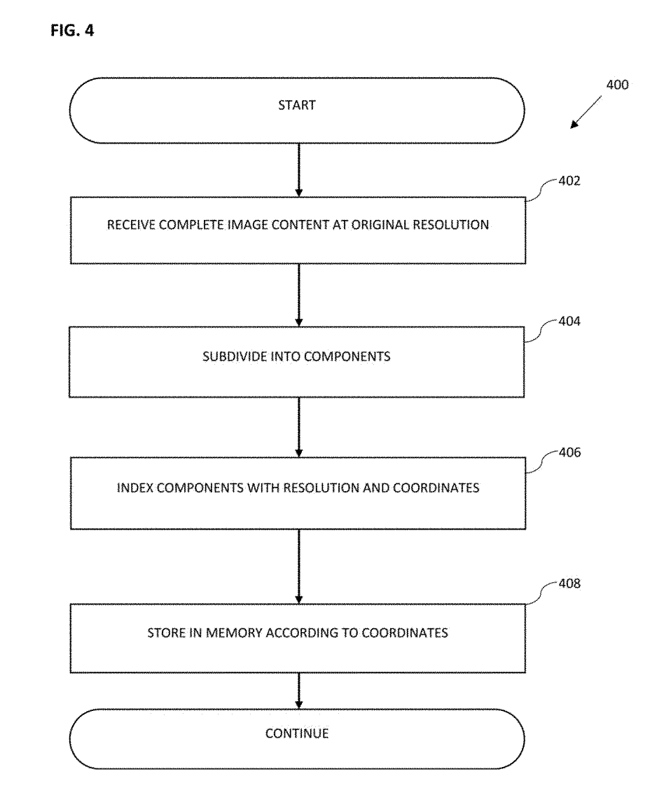

Referring now to FIG. 4, a generalized method 400 for processing (and in this case storing) various portions of video content for accelerated rendering is disclosed.

At step 402 of the method 400, complete image content is received at an original resolution.

The complete image content determines the image space that can be used to derive any subsequent image and may be sized appropriately. For example, a complete panorama (providing 360° in both horizontal and vertical axis) that is stitched together from six (6) 4K images represents over forty eight (48) megapixels (MP) worth of data, but can be used to generate an image at any view angle and any sub-resolution up to 4K in quality. A 3D imaging space (such as may be used in medical imaging, geological survey, and/or computer aided design (CAD)) can incorporate not only the necessary imaging data but also e.g., other metadata for data visualization (described in greater detail hereinafter).

Traditional image formats were directed to flat displays and are generally two dimensional (2D) Cartesian arrays (e.g., X and Y Cartesian coordinates) of pixel values, however it is appreciated that other coordinate systems may be used with equivalent success. For example, three dimensional (3D) Cartesian formats (e.g., X, Y, Z) may be used to provide data within a 3D space (e.g., for medical imaging applications, geophysical survey, etc.) Still other formats may be based on polar coordinates. For example, a 2D polar coordinate system may provide image projection at any view angle (e.g., polar coordinate (θ), azimuthal coordinate (φ))). Similarly, spherical coordinates (e.g., r, θ, φ) can be used to represent a full 3D space. Still other image coordinate systems may be used consistent with the various principles described herein.

While the present disclosure primarily describes image content, it is appreciated that other forms of media may be used. For example, image content may be collated over a number of frames to form video content. Similarly, image content may be augmented with other types of content (e.g., audio, text, metadata, error correction data, etc.) More directly the complete image content may include any information or parameter associated with a particular location coordinate that may be selectively used during the rendering process. For instance, a 3D medical imaging model may incorporate information regarding e.g., tissue type, temperature, chemical composition, blood oxygenation, etc. Similarly, a 3D geophysical survey model may not only include imaging data, but may also include information as to e.g., mineral content, water content, pH and/or alkalinity, etc.

In some embodiments, the image content may be received from a camera system (such as that described in FIGS. 1 and 2, supra). In some cases, the complete image content includes one or more still images that at least partially overlap, and can be stitched together to provide a contiguous image space. In other cases, the complete image content may include a pre-stitched image (e.g., where the camera includes pre-processing, etc.) In still other embodiments, the image content may be retrieved from an external content source such as a content delivery network, computing appliance, etc. In certain use scenarios, the image content may be a combination of both camera and external data (such as may be useful for augmented or hybrid reality type applications.)

Typically, the original image resolution provides the highest source resolution; subsequent derivative images may be generated up to, but cannot exceed the original image resolution. However, in some applications the original image resolution can be extrapolated and/or interpolated to generate even higher resolution graphical content. Common examples of such content include e.g., vector-based computer images, up-sampled images (based on multiple view angles and/or capture times), and/or virtualized objects. Other schemes for improving graphical resolution can include predictive technologies e.g., velocity based prediction, interferometry processing, etc.

In some circumstances, the original image content may have portions which have diminished quality and/or resolution. For example, images that are stitched together may require some degree of extrapolation/interpolation that would detract from the original capture quality. Consider for instance a multiple camera system, wherein different resolution cameras may be used for different viewing angles (e.g., a “frontal” camera may be at a higher resolution than peripheral cameras, etc.). Another example of resolution mismatch may occur where disparate portions of the image content are combined from different sources, such as external content networks and/or computer generated images and local camera inputs. For example, a captured image that is augmented with content received from a website may have different resolution qualities. Still another factor to consider is the inherent capture camera capabilities; for example, a distortive camera lens may result in certain areas of lower resolution quality. Spatially variable image encoding and quality parameters associated with spherical lens formats are broadly described in e.g., U.S. Provisional Patent Application Ser. No. 62/351,818 entitled “APPARATUS AND METHODS FOR IMAGE ENCODING USING SPATIALLY WEIGHTED ENCODING QUALITY PARAMETERS” filed on Jun. 17, 2016, the foregoing being incorporated herein by reference in its entirety.

At step 404 of the method 400, the complete image content is subdivided into components, where the components are associated with varying image resolutions. Unlike traditional storage schemes which store independent resolutions (e.g., a high resolution and a low resolution version of the same image), various aspects of the present disclosure store components that can be additively combined for higher resolution. More directly, as described in greater detail hereinafter, any one of a number of image resolutions may advantageously be reconstructed from the components.

In one exemplary embodiment, the components comprise varying levels of frequency and/or energy information. As a brief aside, video processing may include performing certain transforms on a raw video image (such as e.g., the discrete cosine transform (DCT) and wavelet-based encoding) to assist in encoding and decoding and/or compression and decompression. For example, by converting the raw video image to its spatial frequency components (as distinguished from frequency in time), overall processing complexity can be reduced by weighting and/or filtering out higher frequency components. However, high frequency components are needed for higher resolution content to provide sharp edge resolution in the image. In other words, image resolution and rendering complexity can be changed by including (or excluding) high frequency (high energy) content.

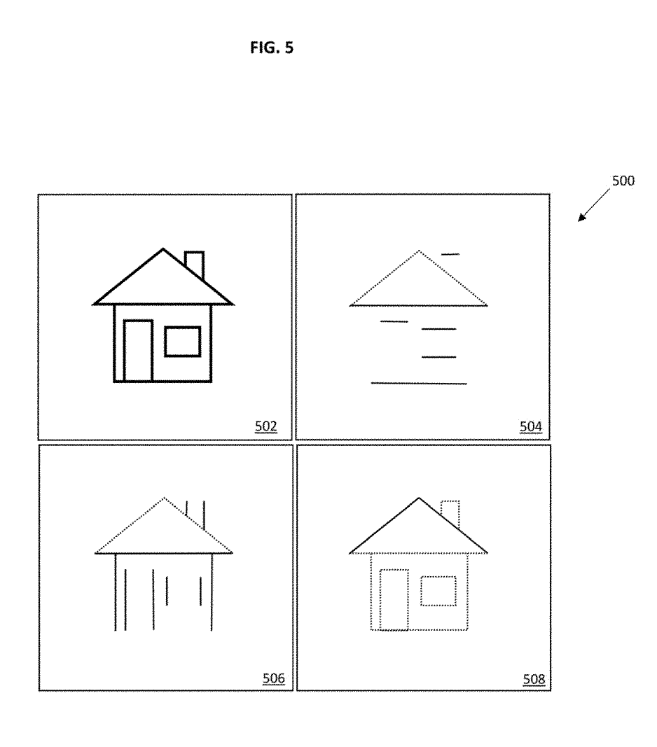

In some variants, the frequency and/or energy information is associated with one or more dimensions of the image. Common examples of dimensions of an image include without limitation: vertical (width), horizontal (length), depth, radial angles, and azimuthal angles.) In one exemplary format, the frequency information is associated with the length and width of a 2D image. For example, FIG. 5 illustrates one exemplary wavelet encoding format that includes four (4) or more separate components: a coarse component (LL) 502, a horizontal edge component (HL) 504, a vertical edge component (LH) 506, and a diagonal edge component (HH) 508. One such exemplary format is described within U.S. patent application Ser. No. 13/113,950 entitled “ENCODING AND DECODING SELECTIVELY RETRIEVABLE REPRESENTATIONS OF VIDEO CONTENT” filed on May 23, 2011, now issued as U.S. Pat. No. 9,171,577, incorporated herein by reference in its entirety.

As a brief aside, under the wavelet encoding scheme, the spatial pixel values of the image content are encoded within the frequency domain as a function of wavelets of varying frequency (similar to the more common discrete cosine transform (DCT), or other Fourier series transforms (e.g., discrete Fourier transform (DFT), fast Fourier transform (FFT), etc.) The wavelet encoding technique offers a number of well-known advantages for post-processing, storage, etc. which are not described in further detail herein. The wavelets must be transformed back to the spatial domain for display. The wavelet encoding technique provides the benefit of arbitrary addressability at any resolution. For example, the arbitrary selection of any pixel (or group of pixels) at any resolution can be transformed for display under the exemplary wavelet encoding scheme.

Referring back to the aforementioned wavelet components (LH, HL, LH, HH) of FIG. 5, each of the wavelet components can be further sub-divided to any degree of granularity. For example, the half resolution component (i.e., LL) may be further sub-divided into four (4) sub-components: LLLL, LLHL, LLLH, LLHH, where LLLL is a quarter resolution component and the other components represent corresponding horizontal, vertical, and diagonal edge components respectively. During re-construction, the half resolution component (i.e., LL) can be derived from its sub-components: LLLL, LLHL, LLLH, LLHH. By extension, further sub-dividing the quarter resolution component (i.e., LLLLL) into LLLLLL, LLLLHL, LLLLLH, LLLLHH, provides an eighth resolution format. Thus, a wavelet encoded bitstream of the components: LLLLLL, LLLLHL, LLLLLH, LLLLHH, LLHL, LLLH, LLHH, HL, LH, and HH can be used to render resolutions at any of an eighth, quarter, half, and full resolutions. Notably, the quarter resolution component (i.e., LLLL) and half resolution component (i.e., LL) can each be generated from other components of the bitstream (and may be excluded for space or transfer considerations).

Any number of degrees of sub-division can be implemented consistent with the wavelet encoding scheme so as to enable the arbitrary selection of any one of the multiple resolutions within a single encoded file. More directly, the foregoing wavelet encoding scheme allows fast access to multiple different resolutions with very little processing burden. For example, the content of interest may be sourced from the full resolution components, whereas the boundary content may be sourced from the half resolution components.

While various embodiments of the present disclosure are illustrated with reference to the aforementioned wavelet encoding scheme, artisans of ordinary skill in the related arts, given the contents of the present disclosure, will readily appreciate that the techniques described herein may be extended to any multiple resolution coding technique. Common examples include the SMPTE 2073 family of encoding standards (also known as VC-5); these include without limitation: SMPTE ST 2073-1, SMPTE ST 2073-3, SMPTE ST 2073-4, each of the foregoing incorporated herein by reference in its entirety.

Additionally, while the foregoing discussion is presented primarily within the context of spatial dimensions of a 2D image, any combination of other dimensions may be used. For example, video based content may be constructed from images that are sequentially linked in time; thus, time could be treated as a dimension. Additional components could be horizontal edges over a coarse time interval, vertical edges over a coarse time interval, and coarse resolution over a fine time interval, etc. Similarly, 3D modeling may provide components over three (3) distinct spatial dimensions (length, width, depth) and possibly over time. Various other permutations and/or combinations will be readily appreciated, given the contents of the present disclosure.

Still other variants may have multiple tiers of resolution. More directly, the foregoing components are based on a down sample factor of two (2): e.g., the coarse component (LL) is at half the vertical and horizontal resolution of the original image. The edge components are at full resolution for only one or two of the dimensions. Thus other variants may offer higher degrees of down-sampling (e.g., four (4), eight (8), sixteen (16), etc.), and or different angular diagonals (e.g., 30° and 60°, etc.)

In other variants, the frequency and/or energy information may be associated with subsections or “regions” of the complete image content. For example, the complete image content may be sub-sectioned off into “tiles”, “slices” or “bands” (e.g., under a Cartesian coordinate system), “rings” or segments thereof (under a polar coordinate system), etc. Still other polygons or volumes may be substituted with equivalent success, by an artisan of ordinary skill in the related arts, given the contents of the present disclosure. For example, in 3D image content, the frequency information may be organized according to “cubes” or spherical “shells”, etc. Similarly, for images which are to be overlaid on background images (such as is done with augmented reality type applications), only the image itself (not the background space) is associated with the frequency/energy information.

Various combinations and/or hybrids of the foregoing may be used with great success. For example, tiles of an image may be further subdivided into various frequency sub-components. Still other variants may have some tiles that have varying levels of frequency sub-components; for example, certain tiles that require high resolution may be further subdivided into frequency sub-components, whereas relatively unimportant tiles may be a standalone tile or only have a coarse sub-component. Alternatively, the frequency components may be tiled or sliced, consistent with the description above.

More generally, any reversible scheme for distilling an image into its constituent components and/or that can be used to generate scalable resolutions, may be substituted for the exemplary wavelet-encoding scheme with equivalent success. While the foregoing discussion is presented primarily within the context of non-lossy techniques, artisans of ordinary skill in the related arts will readily appreciate that lossy techniques may be used, provided that the resulting resolution remains acceptable for the intended application.

At step 406 of the method 400, the components are indexed corresponding to their associated resolution and coordinates within the image content. Each of the components is further indexed within a coordinate space such that any arbitrary portion thereof may be retrieved. One straightforward scheme for indexing is based on the location coordinate system (e.g., Cartesian, polar, etc.) Other more complicated indexing schemes may arrange the information based on other considerations; for example, some schemes may index the component information according to a caching scheme (most recently used (MRU), least recently used (LRU), etc.) and/or a hashing scheme. Still other indexing schemes may be organized according to historical usage and/or predicted usage. For example, medical imaging may be optimized according to common biological features (e.g., skin tones, etc.) and/or commonly used diagnostic features (e.g., MRI cut-away, etc.)

In one exemplary scheme, location coordinates within each of the image components may be arbitrarily accessed within at least a portion of the overall image. More directly, accessing any particular pixel or set of pixels does not require a full decode of the entire image. For example, pixel information of any location and or amount may be addressable as a function of coordinates within the image (e.g., an X and Y coordinate). In entropy encoded embodiments, the image components may be compressed according to a variable length encoding (to e.g., maximize compression, etc.); for example, an entire row may be needed to decode the horizontal edge information for that row within the horizontal edge component. Under such schemes, the image components may be indexed according to a component specific scheme. For example, the coarse components may be tiled (which defines a very specific set pixel information as a function of row and column), whereas the horizontal edge components may be associated with horizontal “bands” of row pixel information, and the vertical edge components may be associated with vertical “slices” of column pixel information. Multiple tiles, slices or bands may be used to render a display.

Referring back to the exemplary wavelet encoding of FIG. 5, the four (4) components (coarse component (LL), horizontal edge component (HL), vertical edge component (LH), and diagonal edge component (HH)) were transformed from, and have lengths that correspond to, the original image. The coarse component represents a down-sampled version (by a factor of two (2)) of the original image whereas the edge components retain the original image dimensions (but only the “edge” or difference data between neighboring pixels). Each of the components is then entropy encoded to maximally compress the information; edge data tends to be predominantly “empty” space, thus the edge components experience significant compression advantages. Common examples of such coding are so-called Huffman coding, unary coding, Golomb coding, Shannon coding, etc.

As previously noted, entropy encoded data is of variable (unpredictable) size and is not arbitrarily addressable; thus the components must be decoded back to the wavelet encoding before they can be transformed to the image domain. One method of minimizing the addressability limitations of entropy encoded data is to pre-segment the frame into e.g., tiles, slices, and/or bands. More directly, the entropy encoded data is spatially subdivided to preserve some limited amount of arbitrary addressability. In order to recover the wavelet encoding's properties for arbitrary access to any pixel (or group thereof) at any resolution, the corresponding entropy encoded regions must be decoded (e.g., a number of tiles, slices or bands). For example, in order to get the edge data for a particular horizontal row, the band for that row must first be entropy decoded, and then decoded with the wavelet transform.

At step 408 of the method 400, the components are stored within a memory or other non-transitory computer readable medium according to their index. Common examples of memory include, without limitation, random access memory (RAM) (such as dynamic RAM (DRAM), synchronous DRAM (SDRAM), static RAM (SRAM), etc.), non-volatile “flash” memory (such as may be found in ICs or solid state drives (SSD)), and/or ferromagnetic based memories (such as are commonly found in hard drives (HDD), etc.) Memory may be located locally at a device and/or externally on the cloud or other network appliance.

Notably, various devices may have different “tiers” of memory hierarchy serving different system purposes. Locally addressable memory may be used for information that must be immediately available, whereas external memories may be used for long-term storage of information, etc. To these ends, components may be stored in different formats depending on where the component is to be stored. For example, the aforementioned entropy encoding steps may be done primarily for the benefit of long-term storage, whereas local memory may store the content without entropy encoding so as to minimize unnecessary decompression time. In some cases, where network reliability is an issue, the content may be delivered to the rendering device while still entropy encoded (and possibly also channel encoded for reliable delivery over a noisy channel) so as to operate within the limited bandwidth constraints.

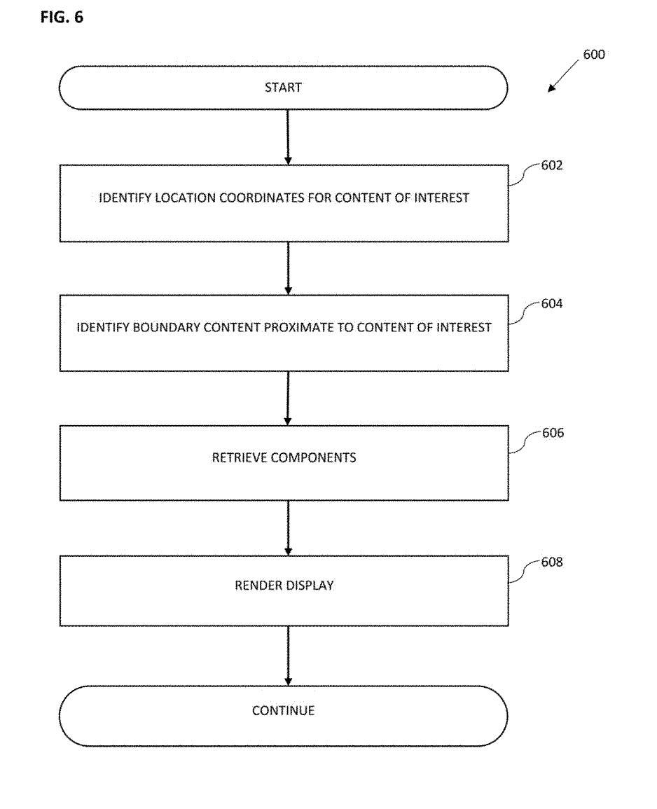

Referring now to FIG. 6, a generalized method 600 for selective retrieval of various portions of video content for accelerated rendering of an image at one or more resolutions is disclosed. Rendering a complete image at the highest resolution is undesirable where only a portion of the image is needed (such as is the case with panoramas, “foveated” viewing, VR and VR-like applications). In particular, only a portion of the image may be of interest for viewing and/or buffering for likely viewing. Similarly, portions of the image that are relatively uninteresting and/or largely undifferentiated may not need to be rendered at full resolution (e.g., a blue sky need not be rendered in full definition, etc.) On the other extreme, portions of the image that are moving faster than the viewer's ability to fully focus may also be rendered at a lower resolution.

At step 602 of the method 600, the location coordinates for content of interest within a complete image content are identified. In some cases, the content of interest refers to all of the content that is rendered for display (e.g., the entire displayed screen). In other cases, the content of interest only refers to a portion of the content that is rendered for display (e.g., where focus is isolated to only a portion of an image, also referred to as “foveated” viewing). In still other cases, the content of interest refers to the content that is rendered for display, and a portion of content that is being buffered for display (e.g., for performance reasons, the edges of the screen may be pre-rendered for faster response times).

Components for reproducing boundary content are retrieved at a lower resolution than the content of interest. In some cases, boundary content may be displayed (e.g., the out-of-focus or otherwise acceptably low resolution portions of the display). In other cases, boundary content is buffered for use in rendering future content of interest (e.g., based on additive combination with other components). Still other hybrid schemes may only display boundary content under circumstances that prevent a full resolution display e.g., where a panning rate exceeds the ability of a full resolution rendering, or where a network bottleneck prevents full resolution data from being delivered in a timely fashion.

Under initial viewing conditions, the location coordinates may be initialized to the default image coordinates. For example, a panoramic vista of the Statue of Liberty may be centered on, and initialized to the face of the statue. In other common cases, the location coordinates may not be in the center and may be initialized at a likely point of interest (e.g., where the composition of an image is on an offset, such as according to the proverbial “Rule of Thirds”).

In other embodiments, the location coordinates may be initialized based on user input (e.g., where a user is looking or pointing a camera capture device). In one exemplary VR head set, the content of interest changes based on head tilt information such as pitch (looking up/down), yaw (looking left/right), and roll (tilting clockwise/counter-clockwise). VR head sets may use accelerometer information that is attached to the head set to identify the user's head tilt. In more sophisticated cases, the user's attention may be tracked based on facial recognition software (e.g., via a camera that captures the user's face) and/or eye-tracking (e.g., via a camera that tracks the pupils of the eyes). More directly, the human eye has a relatively small view angle (less than a 15° view angle). By moving a foveated view of the full resolution content to follow the eye-tracking software, the user will be unable to discern the lower resolution portions of the display; at the same time, significantly less data may be provided since only a relatively small portion of the display is running at full resolution. Still other more direct schemes may follow a user's manual or voice instruction; common examples of such inputs include e.g., a keyboard and mouse, gesture and/or pointing inputs, microphone, etc.

In one embodiment, the content of interest is based on probable user interest. User interest can be actively determined from empirically gathered user data, such as historical viewing data, pre-defined user interests, crowd-sourced information, etc. In other cases, user interest may be passively determined based on artifacts of the media, and circumstances of viewing and/or creation. Anecdotally, user interest is drawn to areas of high contrast and/or motion within image content. For example, viewers are likely to focus on e.g., an animal moving through grass, or a mountain peak against a blue sky. In authored media (e.g., video games, movies, artistic photography, etc.), the author of the media may have identified location coordinates of interest (either directly or indirectly by virtue of composition). Still other schemes for identifying content of interest may be used, consistent with the principles described herein.

At step 604 of the method 600, boundary content proximate to the content of interest is identified. In one exemplary embodiment, an amount and resolution quality of the content of interest and the boundary content is determined relative to the location coordinates. In some cases, the amount and resolution of the content of interest relative to the boundary content is a fixed parameter. For example, content of interest may be statically fixed to a specific resolution (e.g., full resolution) and the boundary content fixed at a lower resolution (e.g., down sampled by two (2), etc.). In one such case, the boundary content uniformly borders the content of the interest.

More sophisticated implementations may adjust the amount, border region, and/or resolution of the boundary content so as to improve e.g., power consumption, performance, rendering latency, processing burden, memory usage, etc. In one embodiment, the boundary content may be selected based on user movement or other user input. For example, in some cases, the amount and resolution of the content of interest relative to the boundary content is identified based on the level of zoom. In other words, if a user is zoomed in, then subsequent displays are likely to be at a similar zoom scale; if the user is zoomed out, then the boundary content should also be scaled a commensurate amount. In another example, if the user is panning to the left, the rendering device can pre-fetch more boundary data to the left based on the assumption that the user will continue to pan to the left. Alternatively, the rendering device can pre-fetch more boundary data to the right, anticipating that the user is more likely to turn back. In still other scenarios, the user's turn rate may determine how much boundary content, or to what resolution the boundary content, should be pre-fetched. For instance, a user that is rapidly scrolling may be in a “scanning” mode where high resolution is less important than responsiveness. Once the user slows down his scrolling rate, higher resolution may be more important than responsiveness.

In other embodiments, the amount and resolution of the content of interest relative to the boundary content is selected based on the rendering capabilities of the display device. Historically, devices have been single function devices e.g., a VR head set had certain fixed rendering capabilities; however, as previously alluded to, the increasing prevalence of VR-content on non-VR specific devices has changed this paradigm. In particular, the rendering capabilities of a display device may be dynamically changing as a function of e.g., battery power, application load, network connectivity, user interaction, etc. For example, a user walking around a city with an augmented reality application may be simultaneously engaging in any number of applications; such as, e.g., cellular data transactions, geolocation, VR-like rendering, camera captures, and other miscellany. To these ends, the device may choose to render less content of interest and/or pre-fetch less boundary content to reduce power consumption. In contrast, a user (with the same device) playing a first person shooter game at home on a Wi-Fi connection while running from a wall outlet will have very different considerations. Under such circumstances, the device may increase its processing burden and power consumption to maximize the game's performance. Artisans of ordinary skill in the related arts, given the contents of the present disclosure, will readily appreciate the wide variety of usage scenarios, device constraints, and consumer preferences that may be dynamically considered by the device when determining the amount and resolution of the content of interest relative to the boundary content.

There may be considerations outside of the device's control that affect the amount and resolution of the content of interest relative to the boundary content. For example, the rendering device may need to compensate for issues within the delivery infrastructure. Spotty wireless reception can be managed with intelligent buffering (e.g., caching more and larger portions of content of interest and/or boundary content). Similarly, where a content server is rendering content for the display device and has reduced processing capability, it may be necessary for the display device to compensate for the content server's load and e.g., cache more components and/or larger portions of higher resolution content rather than request it on an as-needed basis. In still other cases, the device may be put on notice that the currently delivered content is likely to go “stale”; responsively, the device may opt to minimize the amount of boundary content it pre-fetches (as it is unlikely to be helpful).

The amount and resolution of the content of interest relative to the boundary content may be configurable by the user according to e.g., a user setting. Certain “power” users are well versed in the arts and may be in the best situation to manage their own usage experience. Perhaps the user is more concerned with battery consumption than performance (or vice versa). Such configurability can be directly enforced or indirectly managed in view of the other considerations described supra.

At step 606 of the method 600, one or more components are retrieved based on the location coordinates and resolution parameters associated with the content of interest and the boundary content. Content may be retrieved from a local buffer of content or from an external store of content. In some embodiments, the retrieved content is retrieved in an arbitrarily addressable format; in other embodiments, the retrieved content must be entropy decoded before it can be arbitrarily addressed. As previously noted supra (see discussions regarding FIG. 4), content retrieval may be based on a caching or hashing scheme to streamline indexing operations based on the imaging spatial coordinates.

In some embodiments, the device may additionally check to determine which ones of the content of interest and/or boundary content should be retrieved. Certain techniques with “additive” combination properties may reuse different components. For example, the aforementioned exemplary wavelet encoding techniques can convert a coarse component into a full resolution image by additively combining the various edge components. Since the coarse component is the pre-fetched boundary content, only the corresponding edge components need to be retrieved in order to create the full resolution image. Since the edge components can be heavily entropy encoded, their overall delivery size can be delivered over limited bandwidth connections.

At step 608 of the method 600, an image for display is rendered from the retrieved components. In one exemplary embodiment, the content of interest can be additively generated based on previously buffered boundary content and/or supplemental components. Within the context of the foregoing wavelet encoded scheme of FIG. 5, the full resolution image can be reconstituted by combining the coarse component (LL), with each of the edge components (HL, LH, HH).

Artisans of ordinary skill in the related arts will readily appreciate that the various principles described herein may be used for components that are provided at different times and/or when referencing different location coordinates (so long as the underlying image data has not changed). More generally, the content of interest may be retrieved with reference to previously received information whenever or however retrieved.

In some embodiments, the device may additionally intelligently manage its buffers. For example, a device may limit the amount of data which can be locally stored; however, rather than always flushing the old image data, the device may only flush edge components. For example, consider a rendering device that can store the components for a full resolution derived image of interest, and limited boundary content for the periphery. When the user looks at the center of an image, the rendering device locally stores the content of interest and its corresponding boundary content. If the user looks to the left, the boundary content that corresponded to the left of the content of interest is combined with supplemental content to generate a full resolution image of the left vantage point. At the same time, the central image components can be flushed to make space for the new boundary components (the central coarse component can be saved and does not need to be retransmitted). Once the user returns back to the center of the image, the original central coarse component can be reused to regenerate the high resolution central vantage point. More directly, when a user pans, the device may retain e.g., the coarse component of the old image as boundary content for the new image. In more sophisticated cases, portions of the components can be retained and/or translated; e.g., in a horizontal panning motion, the edge components could be reused if updated with the corresponding horizontal translation.

### Example Operation—

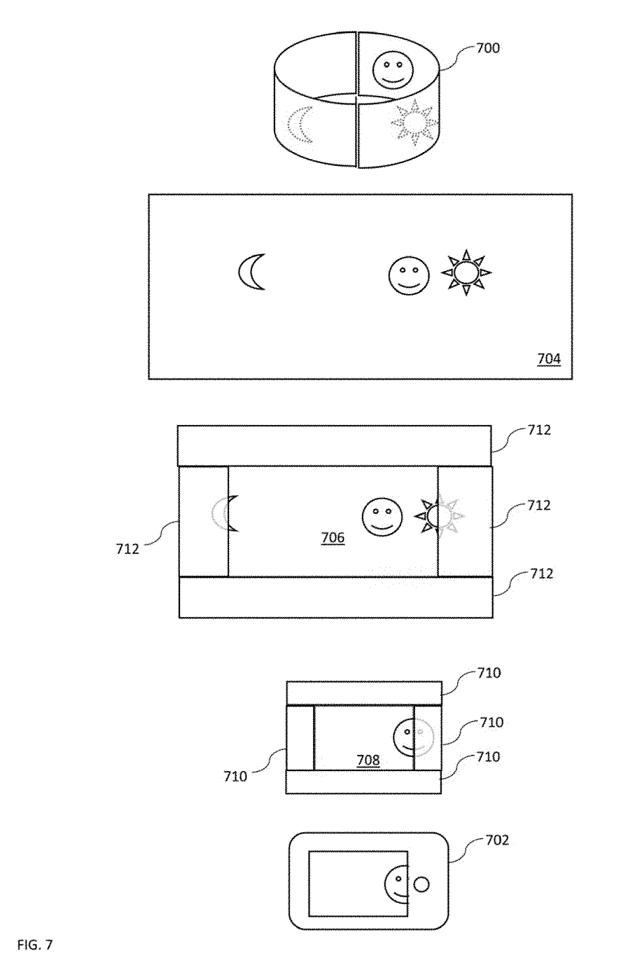

Referring now to FIG. 7, one exemplary scenario is described consistent with the generalized methods described above. As shown, an original full resolution 8K panorama image has a total size of 7680×4320. The 8K image is prepared for rendering on a smart phone 702 with a 1920×1080 display (which is a quarter of the vertical and horizontal dimensions; or 1/16^{th} of the complete image size). The original full resolution 8K image content 700 cannot be rendered in its entirety on the device 702 due to the significantly smaller screen size; instead, the device can render at: (i) a quarter resolution with a 360° FOV panorama 704 (i.e., the entire 7680×4320 is down sampled in both vertical and horizontal dimensions by a factor of four (4)), (ii) a half resolution with a 180° FOV panorama 706 (i.e., half of the 7680×4320 image is down sampled by a factor of two (2)), and (iii) a full resolution with a 90° FOV image 708 (i.e., a quarter of the 7680×4320 image is displayed without down sampling).

Initially, the original full resolution 8K image content is wavelet encoded into a multiple resolution bitstream. Specifically, the complete 8K image content is first sub-divided into a half resolution component (LL) and corresponding edge components (HL, LH, HH). The half resolution component is then further subdivided into a quarter resolution component LLLL, and corresponding edge components LLHL, LLLH, LLHH. Thus, the complete bitstream includes: LLLL, LLHL, LLLH, LLHH, HL, LH, and HH which can be used to render resolutions at any one of a quarter, half, and full resolutions. As previously noted, the half resolution component (LL) could be reconstituted from LLLL, LLHL, LLLH, LLHH, and thus may be removed from the bitstream to save memory space or reduce transmission overhead. Alternatively, the half resolution component (LL) may be included in the bitstream so as to reduce processing burden on the display device (i.e., the display device need not generate the half resolution component (LL) from its constituent sub-components).

During viewing, the user selects the third option (a full resolution 90° FOV image); responsively, the phone retrieves and renders a 90° FOV image of the content of interest at full resolution, but also retrieves boundary content 710 sufficient to render 30° on the sides of the content of interest. More directly, the phone retrieves the four (4) separate components for the content of interest: a coarse component (LL), a horizontal edge component (HL), a vertical edge component (LH), and a diagonal edge component (HH) for the 90° range. Additionally, the phone retrieves and buffers only the LL component for the 30° buffers of the image. When the user pans his phone to the left and right, the phone responsively retrieves the edge components for the corresponding amount of panning motion to render the full resolution panned image; additionally, the phone may refresh the LL component on either side of the panned image to ensure that the 30° buffers of the image remain full.

As should be apparent from the foregoing, the buffered boundary content is local to the display device and does not need to be transferred in order to render the image. This buffering allows for faster responsiveness by: (i) allowing for immediate display of a lower resolution image (which may be acceptable since the user is unlikely to focus on any particular detail while moving), and (ii) reduces the amount of data which needs to be transferred in order to render the high resolution image. These benefits ensure that the user does not experience a lagging image when moving.

Next, the user zooms out of the 90° FOV image to the half resolution 180° FOV panorama. Since the LL component is a half resolution version of the original image, the current LL component for the content of interest can be reused. Additionally, since the 30° buffers of the image are also pre-fetched with LL components they can be directly reused as well. Thus, only LL components for 15° on either side of the previous content need to be fetched to render the display (i.e., the 90° FOV coarse component and its 30° buffers represent 150° of the half resolution 180° FOV). However, in addition, the device also needs to populate new boundary content buffers 712. Since the display is zoomed out, the buffers also need a corresponding increase (e.g., 60° of quarter resolution on either side of the half resolution content). Accordingly, the buffers are populated with corresponding portions of the quarter resolution component (LLLL).

As noted above, when the user pans his phone to the left and right, the phone responsively retrieves the edge components (LLHL, LLLH, LLHH) for the corresponding amount of panning motion to render the half resolution panned image; additionally, the phone may refresh the LLLL component on either side of the panned image to ensure that the 60° buffers of the image remain full.

Finally, the user zooms out of the half resolution 180° FOV panorama to a quarter resolution 360° FOV panorama. As before, the existing portions of the quarter resolution component (LLLL) can be reused, and the device need only fetch the remaining portions of the original content (e.g., 30° of quarter resolution (LLLL)). Since the entire image is presented, buffers are no longer needed to support panning; instead, the panned portions roll over onto the other side of the image.

### Apparatus—

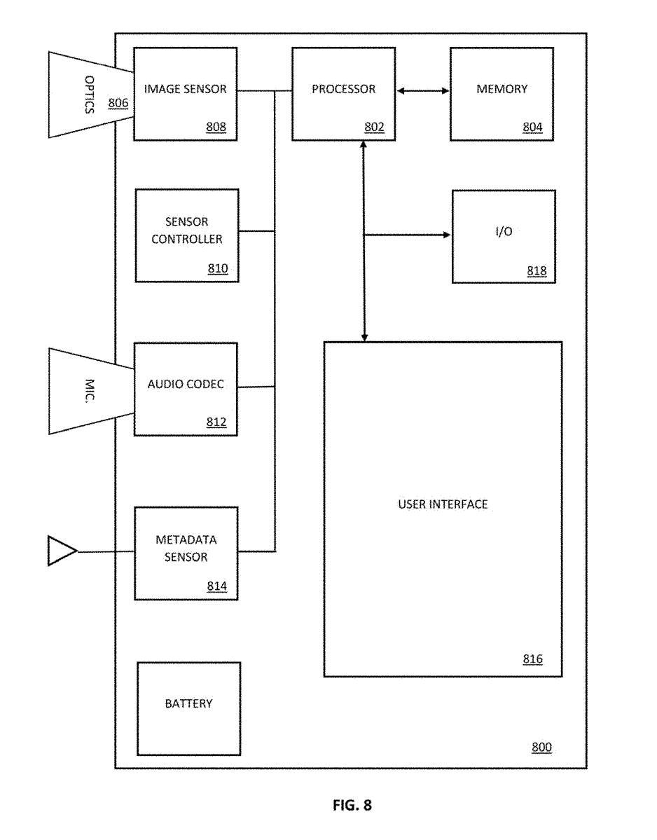

FIG. 8 illustrates one generalized implementation of an apparatus 800 for storing and/or rendering content of interest based on an original image and/or pre-fetched boundary content. The apparatus 800 of FIG. 8 may include one or more processors 802 (such as system on a chip (SOC), microcontroller, microprocessor, central processing unit (CPU), digital signal processor (DSP), application specific integrated circuit (ASIC), general processing unit (GPU), and/or other processors) that control the operation and functionality of the display device 800. In some implementations, the apparatus 800 may correspond to a VR head set or a consumer electronics device (e.g., a smart phone, tablet, PC, etc.) configured to capture, store, and/or render VR and VR-like content.

The apparatus 800 may include electronic storage 804. The electronic storage 804 may include a non-transitory system memory module that is configured to store executable computer instructions that, when executed by the processor(s) 802, perform various device functionalities including those described herein. The electronic storage 804 may also include storage memory configured to store content (e.g., metadata, images, audio) captured by the apparatus 800.

In one such exemplary embodiment, the electronic storage 804 may include non-transitory memory configured to store configuration information and/or processing code to capture, store, retrieve, and/or render, e.g., video information, metadata and/or to produce a multimedia stream including, e.g., a video track and metadata in accordance with the methodology of the present disclosure. In one or more implementations, the processing configuration may be further parameterized according to, without limitation: capture type (video, still images), image resolution, frame rate, burst setting, white balance, recording configuration (e.g., loop mode), audio track configuration, and/or other parameters that may be associated with audio, video and/or metadata capture. Additional memory may be available for other hardware/firmware/software needs of the apparatus 800. The processor 802 may interface to the sensor controller module 800 in order to obtain and process sensory information for, e.g., object detection, face tracking, stereo vision, and/or other tasks.

The apparatus 800 may include an optics module 806. In one or more implementations, the optics module 806 may include, by way of non-limiting example, one or more of standard lens, macro lens, zoom lens, special-purpose lens, telephoto lens, prime lens, achromatic lens, apochromatic lens, process lens, wide-angle lens, ultra-wide-angle lens, fisheye lens, infrared lens, ultraviolet lens, perspective control lens, other lens, and/or other optics component. In some implementations the optics module 806 may implement focus controller functionality configured to control the operation and configuration of the camera lens. The optics module 806 may receive light from an object and couple received light to an image sensor 808. The image sensor 808 may include, by way of non-limiting example, one or more of charge-coupled device sensor, active pixel sensor, complementary metal-oxide semiconductor sensor, N-type metal-oxide-semiconductor sensor, and/or other image sensor. The image sensor 808 may be configured to capture light waves gathered by the optics module 806 and to produce image(s) data based on control signals from the sensor controller module 810 (described below). The optics module 808 may include a focus controller configured to control the operation and configuration of the lens. The image sensor may be configured to generate a first output signal conveying first visual information regarding the object. The visual information may include, by way of non-limiting example, one or more of an image, a video, and/or other visual information. The optical element, and the first image sensor may be embodied in a housing.

In some implementations, the image sensor module 808 may include, without limitation, video sensors, audio sensors, capacitive sensors, radio sensors, accelerometers, vibrational sensors, ultrasonic sensors, infrared sensors, radar, LIDAR and/or sonars, and/or other sensory devices.

The apparatus 800 may include one or more audio components 812 e.g., microphone(s) and/or speaker(s). The microphone(s) may provide audio content information. Speakers may reproduce audio content information.

The apparatus 800 may include a sensor controller module 810. The sensor controller module 810 may be used to operate the image sensor 808. The sensor controller module 810 may receive image or video input from the image sensor 808; audio information from one or more microphones, such as 812. In some implementations, audio information may be encoded using audio coding format, e.g., AAC, AC3, MP3, linear PCM, MPEG-H and or other audio coding format (audio codec). In one or more implementations of “surround” based experiential capture, multi-dimensional audio may complement e.g., panoramic or spherical video; for example, the audio codec may include a stereo and/or 3-dimensional audio codec.

The apparatus 800 may include one or more metadata modules 814 embodied within the housing and/or disposed externally to the apparatus. The processor 802 may interface to the sensor controller 810 and/or one or more metadata modules. Each metadata module 814 may include sensors such as an inertial measurement unit (IMU) including one or more accelerometers and/or gyroscopes, a magnetometer, a compass, a global positioning system (GPS) sensor, an altimeter, ambient light sensor, temperature sensor, and/or other environmental sensors. The apparatus 800 may contain one or more other metadata/telemetry sources, e.g., image sensor parameters, battery monitor, storage parameters, and/or other information related to camera operation and/or capture of content. Each metadata module 814 may obtain information related to environment of the capture device and an aspect in which the content is captured and/or to be rendered.

By way of a non-limiting example: (i) an accelerometer may provide device motion information, including velocity and/or acceleration vectors representative of motion of the apparatus 800; (ii) a gyroscope may provide orientation information describing the orientation of the apparatus 800; (iii) a GPS sensor may provide GPS coordinates, and time, that identify the location of the apparatus 800; and (iv) an altimeter may provide the altitude of the apparatus 800. In some implementations, the metadata module 814 may be rigidly coupled to the apparatus 800 housing such that any motion, orientation or change in location experienced by the apparatus 800 is also experienced by the metadata sensors 814. The sensor controller module 810 and/or processor 802 may be operable to synchronize various types of information received from the metadata sources 814. For example, timing information may be associated with the sensor data. Using the timing information metadata information may be related to content (photo/video) captured by the image sensor 808. In some implementations, the metadata capture may be decoupled from video/image capture. That is, metadata may be stored before, after, and in-between one or more video clips and/or images. In one or more implementations, the sensor controller module 810 and/or the processor 802 may perform operations on the received metadata to generate additional metadata information. For example, a microcontroller may integrate received acceleration information to determine a velocity profile of the apparatus 800 during the recording of a video. In some implementations, video information may consist of multiple frames of pixels using any applicable encoding method (e.g., H262, H.264, Cineform® and/or other standard).

Embodiments of either the camera systems and/or hybrid reality viewers may interface with external interfaces to provide external metadata (e.g., GPS receivers, cycling computers, metadata pucks, and/or other devices configured to provide information related to the device and/or its environment) via a remote link. The remote link may interface to an external user interface device. In some implementations, the remote user interface device may correspond to a smart phone, a tablet computer, a phablet, a smart watch, a portable computer, and/or other device configured to receive user input and communicate information. Common examples of wireless link interfaces include, without limitation e.g., WiFi, Bluetooth (BT), cellular data link, ZigBee, near field communications (NFC) link, ANT+ link, and/or other wireless communications link. Common examples of a wired interface include without limitation e.g., HDMI, USB, DVI, DisplayPort, Ethernet, Thunderbolt, and/or other wired communications links.

The user interface device may operate a software application (e.g., GoPro Studio, GoPro App, and/or other software applications) configured to perform a variety of operations related to camera configuration, control of video acquisition, and/or display of video. For example, some applications (e.g., GoPro App) may enable a user to create short video clips and share clips to a cloud service (e.g., Instagram, Facebook, YouTube, Dropbox); perform full remote control of the device, preview video being captured for shot framing, mark key moments while recording (e.g., with HiLight Tag), view key moments (e.g., View HiLight Tags in GoPro Camera Roll) for location and/or playback of video highlights, control device software, and/or perform other functions.

The apparatus 800 may also include user interface (UI) module 816. The UI module 816 may include any type of device capable of registering inputs from and/or communicating outputs to a user. These may include, without limitation, display, touch, proximity sensitive interface, light, sound receiving/emitting devices, wired/wireless input devices and/or other devices. The UI module 816 may include a display, one or more tactile elements (e.g., buttons and/or virtual touch screen buttons), lights (light emitting diode (LED)), speaker, and/or other UI elements. The UI module 816 may be operable to receive user input and/or provide information to a user related to operation of the apparatus 800.

In one exemplary embodiment, the UI module 816 is a head mounted display (HMD). HMDs may also include one (monocular) or two (binocular) display components which are mounted to a helmet, glasses, or other wearable article, such that the display component(s) are aligned to the user's eyes. In some cases, the HMD may also include one or more cameras, speakers, microphones, and/or tactile feedback (vibrators, rumble pads). Generally, HMD's are configured to provide an immersive user experience within a virtual reality, augmented reality, or modulated reality. Various other wearable UI apparatuses (e.g., wrist mounted, shoulder mounted, hip mounted, etc.) are readily appreciated by artisans of ordinary skill in the related arts, the foregoing being purely illustrative.

In one such variant, the one or more display components are configured to receive an encoded video stream and render the display in accordance with the spatially weighted encoding quality parameters. For example, spatially weighted quality estimates can help deliver better quality in front of the eye (e.g., for an HMD viewing of spherical video) and much lower quality at the corners of the eye. In one such instance, the display component(s) is further configured to track the eye movement, so as to always present the highest quality video in the focus of the user. In another such variant, one or more cameras mounted on the HMD are configured to record and encode a video stream providing the appropriately spatially weighted encoding quality parameters as described in greater detail herein. In some cases, the HMD's accelerometers and/or other metadata information can be used to further inform and improve the encoding process (e.g., by accounting for motion blur, lighting, and other recording artifacts)

The I/O interface module 818 of the apparatus 800 may include one or more connections to external computerized devices to allow for, inter alia, content delivery and/or management of the apparatus 800. The connections may include any of the wireless or wireline interfaces discussed above, and further may include customized or proprietary connections for specific applications. In some implementations, the communications interface may include a component (e.g., a dongle), including an infrared sensor, a radio frequency antenna, ultrasonic transducer, and/or other communications interfaces. In one or more implementation, the communications interface may include a local (e.g., Bluetooth, Wi-Fi) and/or broad range (e.g., cellular LTE) communications interface configured to enable communications between the apparatus 800 and an external content source (e.g., a content delivery network).

The apparatus 800 may include a power system that may be tailored to the needs of the application of the device. For example, for a small-sized lower power action camera, a wireless power solution (e.g. battery, solar cell, inductive (contactless) power source, and/or other power systems.) may be used.

Where certain elements of these implementations can be partially or fully implemented using known components, only those portions of such known components that are necessary for an understanding of the present disclosure are described, and detailed descriptions of other portions of such known components are omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “content” refers generally to any audio/visual (AV) content including without limitation: images, video, audio, multimedia, etc.

As used herein, the terms “panoramic”, “fisheye”, and/or “spherical” refers generally to image content captured using 180°, 360°, and/or other wide format fields of view (FOV).

As used herein, the terms “rendering”, “reproducing”, and/or “displaying” refer generally to the playback and/or reproduction of content.

As used herein, the terms “virtual reality” (VR) content and/or “VR-like” content refer generally to content that is intended to be rendered with a movable field of view based on arbitrary user input (such as head movements), within a continuous and persistent artificial environment. VR content generally represents an immersive environment, whereas VR-like content may refer to “augmented reality”, “mixed reality”, “mixed virtuality”, “hybrid reality”, and/or any other content that is intended to be viewed to complement or substitute for the user's actual environment.

As used herein, the terms “computer”, “computing device”, and “computerized device”, include, but are not limited to, personal computers (PCs) and minicomputers, whether desktop, laptop, or otherwise, mainframe computers, workstations, servers, personal digital assistants (PDAs), handheld computers, embedded computers, programmable logic device, personal communicators, tablet computers, portable navigation aids, J2ME equipped devices, cellular telephones, smart phones, personal integrated communication or entertainment devices, or literally any other device capable of executing a set of instructions.

As used herein, the term “computer program” or “software” is meant to include any sequence or human or machine cognizable steps which perform a function. Such program may be rendered in virtually any programming language or environment including, for example, C/C++, C#, Fortran, COBOL, MATLAB™, PASCAL, Python, assembly language, markup languages (e.g., HTML, SGML, XML, VoXML), and the like, as well as object-oriented environments such as the Common Object Request Broker Architecture (CORBA), Java™ (including J2ME, Java Beans), Binary Runtime Environment (e.g., BREW), and the like.

As used herein, the terms “integrated circuit”, “chip”, and “IC” are meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the terms “microprocessor” and “digital processor” are meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, and/or other wireless technology), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

As used herein, the term “camera” may be used to refer to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

It will be recognized that while certain aspects of the technology are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

1.-6. (canceled)

7. A method for retrieving various portions of video content data for selective rendering, comprising:
identifying one or more location coordinates associated with content of interest;
identifying boundary content proximate to the content of interest;
retrieving one or more components of an original image associated with the content of interest and the boundary content; and
rendering the content of interest from the retrieved one or more components.

8. The method of claim 7, wherein the identifying one or more location coordinates is based on receiving one or more of roll, pitch, and yaw input from one or more accelerometers of a viewing device.

9. The method of claim 7, wherein the identifying one or more location coordinates is based on receiving eye-tracking information.

10. The method of claim 7, wherein retrieving the one or more components comprises retrieving components associated with different resolution qualities.

11. The method of claim 7, wherein the retrieving one or more components comprises retrieving first components associated with the content of interest and a first resolution.

12. The method of claim 11, wherein the retrieving one or more components comprises retrieving second components associated with the boundary content and a second resolution.

13. The method of claim 12, further comprising rendering at least a portion of the boundary content at the second resolution.

14. The method of claim 12, further comprising buffering at least a portion of the boundary content at the second resolution.

15. An apparatus configured to selectively render a portion of an image at a selected resolution, comprising:
a data interface;
a memory configured to store data relating to a plurality of components associated with an original image;
a processor in data communication with the data interface; and
a storage apparatus having a non-transitory computer readable medium comprising one or more instructions which are configured to, when executed by the processor, cause the apparatus to:
retrieve only a subset of the data relating to the plurality of components, the subset associated with content of interest and boundary content;
wherein the components associated with the content of interest have a different resolution from that of the components associated with the boundary content; and
cause provision of at least the content of interest to a display device via the data interface, so as to enable rendering of a display thereof.

16. The apparatus of claim 15, further comprising one or more accelerometers; and
wherein the content of interest is determined based on input from the one or more accelerometers.

17. The apparatus of claim 15, further comprising one or more eye-tracking cameras; and
wherein the content of interest is determined based on input from the one or more eye-tracking cameras.

18. The apparatus of claim 15, further comprising computerized logic configured to determine a total number of components of the subset based on a processing limitation of the processor or a memory limitation of the memory.

19. The apparatus of claim 18, wherein the enabled rendering is based on a first set of components associated with the content of interest.

20. The apparatus of claim 18, wherein the enabled rendering is also based on a second set of components associated with the boundary content.

21. A non-transitory computer-readable apparatus having a computer program stored thereon, the computer program comprising a plurality of instructions that are configured to, when executed by a processor apparatus, cause the processor apparatus to:
identify one or more location coordinates associated with at least a portion of image content;
identify boundary content relative to the one or more location coordinates associated with the at least the portion of the image content;
retrieve one or more components of an original image associated with the image content and the boundary content; and
render the at least the portion of image content from the retrieved one or more components.

22. The non-transitory computer-readable apparatus of claim 21, wherein:
the one or more components comprise a first component and a second component, the first component and the second component being associated with the at least the portion of image content;
the first component comprises buffered content;
the second component corresponds with the first component, the second component comprising at least partially encoded content; and
the plurality of instructions are further configured to, when executed by the processor apparatus, cause the processor apparatus to combine the first and the second component to obtain the at least the portion of image content.

23. The non-transitory computer-readable apparatus of claim 21, wherein the plurality of instructions are further configured to, when executed by the processor apparatus, cause the processor apparatus to determine a total number of components of the one or more components based on a processing limitation of the processor apparatus.

24. The non-transitory computer-readable apparatus of claim 21, wherein:
the plurality of instructions are further configured to, when executed by the processor apparatus, cause the processor apparatus to buffer at least a portion of the boundary content; and
the buffered at least the portion of the boundary content comprises a selection of the at least the portion of the boundary content based on user action.

25. The non-transitory computer-readable apparatus of claim 21, wherein the at least the portion of image content comprises content of user interest; and
wherein the plurality of instructions are further configured to, when executed by the processor apparatus, cause the processor apparatus to determine the content of user interest based on a likelihood of user interest associated with the at least the portion of image content.

26. The non-transitory computer-readable apparatus of claim 25, wherein the determination of the content of user interest is further based on input from an eye-tracking camera or an accelerometer.
